(19) United States
(12) Patent Application Publication
(10) Pub. No.: US 2008/0008869 A1
(43) Pub. Date: Jan. 10, 2008

(54) Enhanced sound absorption in thermoplastic composites

(76) Inventors: Brian Timothy Good, Forest, VA (US); Thomas Arnold Ebeling, Forest, VA (US)

Correspondence Address: MARK L. WARZEL, 10252 OVERHILL DRIVE, SANTA ANA, CA, 92705, US

(21) Appl. No.: 11/805,259

(22) Filed: May 21, 2007

Related U.S. Application Data
(60) Provisional application No. 60/801,640, filed on May 19, 2006.

(51) Int. Cl. B32B 5/16; B29C 44/12; B32B 17/06; B32B 27/00; B32B 9/04; B32B 27/08; B32B 27/36

(52) U.S. Cl. 428/311.51; 264/45.3; 428/411.1; 428/412; 428/423.1; 428/426; 428/474.4; 428/480

(57) ABSTRACT

A moldable composite sheet having enhanced sound absorption characteristics and attenuation of transmitted sound intensities. In one aspect, the composite sheet may be a porous fiber-reinforced thermoplastic comprising discontinuous reinforcing fibers, expandable polymeric beads such as microspheres, and, optionally, one or more thermoplastic skins. Generally, the composite sheet may have a void content or porosity from greater than 0% to about 95% by volume of the sheet, an areal weight between about 400 g/m² to about 4000 g/m² (gsm), a fiber content from about 20% to about 80% by weight, and an expandable polymeric bead content from greater than 0 gsm to about 25 gsm. The composite sheet can be molded via low pressure processes, such as thermoforming, match metal molding on stops, vacuum forming and pressure forming, to produce durable automotive interior trim parts and construction articles having enhanced sound absorption capabilities in addition to other beneficial characteristics.

### CROSS REFERENCE TO RELATED APPLICATIONS

This application claims the benefit of Provisional Patent Application No. 60/801,640, filed May 19, 2006, which is hereby incorporated by reference in its entirety.

### FIELD OF THE INVENTION

This invention relates generally to moldable composite sheet materials, the use of such materials to form moldable articles, and to improvements in certain characteristics, such as sound absorption, of such materials and articles formed therefrom. Specifically, the invention relates to fiber-reinforced composite sheet materials having a beneficial combination of characteristics wherein the composite sheet material exhibits enhanced sound absorption in addition to good rigidity and weight characteristics. Although not limited thereto, the invention is useful in the manufacture of automotive articles, such as headliners, door modules, instrument panel toppers, front and/or rear pillar trims, sunshades, parcel shelves, and package trays, and in construction articles, such as ceiling panels, in which the enhanced sound absorption and structural characteristics provide advantages over other materials utilized for such applications.

### BACKGROUND OF THE INVENTION

Driven by a growing demand by industry, governmental regulatory agencies and consumers for durable and inexpensive products that are functionally comparable or superior to metal products, a continuing need exists for improvements in composite articles subjected to difficult service conditions. This is particularly true in the automotive industry where developers and manufacturers of articles for automotive and construction materials applications must meet a number of competing performance specifications for such articles.

In an effort to address these demands, a number of composite materials have been developed, including glass mat thermoplastic (GMT) composites. GMT composites provide a number of advantages, e.g., they can be molded and formed into a variety of suitable products both structural and non-structural, including, among many others, automotive bumpers, interior headliners, and interior and exterior trim parts. Traditional GMT composites used in exterior structural applications are generally compression flow molded and are substantially void free in their final part shape. By comparison, low density GMT composites used in automotive interior applications are generally semi-structural in nature and are porous and light weight with densities ranging from 0.1 to 1.8 g/cm³ and containing 5% to 95% voids distributed uniformly through the thickness of the finished part. The stringent requirements for certain automotive interior applications have been difficult to meet, however, for existing GMT products, particularly where such applications require a desirable combination of properties, such as light weight, good rigidity and good sound absorption characteristics. As a result, a continuing need exists to provide further improvements in the ability of composite sheet materials such as GMT composites to meet such performance standards.

### SUMMARY OF THE INVENTION

The present invention is addressed to the aforementioned need in the art, and provides a novel composite sheet material having improved sound absorption characteristics. For example, in one aspect, the composite sheet material exhibits enhanced sound absorption characteristics when polymeric beads, such as expandable polymeric microspheres, are incorporated in the core of the composite sheet material. Articles formed from the composite sheet material of the invention may also exhibit improved thermal stability characteristics thereby allowing for the manufacture of new articles requiring such characteristics, particularly in automotive interior applications.

Generally, the moldable composite sheet material comprises a fiber reinforced thermoplastic core that comprises a thermoplastic resin, discontinuous fibers dispersed within the thermoplastic resin, expandable polymeric beads, and, optionally, one or more skin layers on the surface of the fiber-containing thermoplastic resin. In one aspect, the moldable composite sheet material exhibits improved sound absorption characteristics relative to a comparative composite sheet material having discontinuous glass fibers dispersed within the thermoplastic core of the comparative composite material. In another aspect, the composite sheet material exhibits improved sound absorption characteristics relative to a comparative composite sheet material differing from the moldable composite sheet material only in that the thermoplastic resin core material of the comparative composite sheet material does not contain an expandable polymeric bead component. In this regard, the invention is partly attributable to the discovery that beneficial improvements in sound absorption of composite articles may be obtained by incorporating expandable polymeric beads, such as expandable microspheres, in the moldable composite sheet material.

### BRIEF DESCRIPTION OF THE DRAWINGS

FIGS. 1-4 depict experimental data obtained as described in the Examples and analysis of variance contour plots for the various indicated composite sheets at particular areal density (GSM or g/m²) values.

### DETAILED DESCRIPTION OF THE INVENTION

The present invention is more particularly described in the following description and examples that are intended to be illustrative only. Within the context of the invention, numerous modifications and variations therein will be apparent to those skilled in the art.

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a skin layer” or “a surface layer” includes a single layer as well as two or more layers that may or may not be the same and may be on one or more sides or surfaces of the material, and the like.

Also, as used in the specification and in the claims, the term “comprising” may include the embodiments “consisting of” and “consisting essentially of.” All ranges disclosed herein are inclusive of the endpoints and are independently combinable.

As used herein, certain terms and numerical values or ranges may be approximated. For example, the terms “about” and “substantially” are intended to permit some variation in the precise numerical values or ranges specified. While the amount of the variation may depend on the particular parameter, as used herein, the percentage of the variation is typically no more than 5%, more particularly 3%, and still more particularly 1%, of the numerical values or ranges specified. In at least some instances, the approximating language may correspond to the precision of an instrument for measuring the value.

In this specification and in the claims that follow, reference will be made to a certain terms, which shall be defined to have the following meanings:

The term “basis weight” generally refers to the areal density of a fiber reinforced thermoplastic material, typically expressed in grams per square meter (g/m², gsm, or GSM) of the material in sheet form. The term “reduced basis weight” refers to a reduction in the basis weight that may be realized for materials according to the invention relative to other materials not having all of the features of the invention.

The terms “loft” and “loftability factor” generally relate to the dimensional expansion characteristics associated with materials, such as sheets, prepared from thermoplastic resin and fiber components. For example, sheet materials prepared from a thermoplastic resin containing glass fibers typically exhibit a certain degree of expansion, i.e. “loft”, when such sheets are subsequently subjected to molding operations. The amount of loft depends on a number of factors, such as the loading amount, type and property characteristics of the fiber component, the amount and type of thermoplastic resin(s), as well as the steps used to form the sheet and subsequently mold it. The “loftability factor” provides a useful way to compare such materials for different fiber loading amounts:

$$Loftability Factor = \frac{Measured Free Loft ( mm )}{Theoretical Consolidated Thickness}$$

where the calculated theoretical consolidated thickness is determined based on the theoretical consolidated density and material weight:

$$Theoretical Consolidated Density = \frac{1}{( \frac{fiber fraction}{fiber density} ) + ( \frac{resin fraction}{resin density} )}$$

and the theoretical consolidated thickness is determined as:

$$Theoretical Consolidated Thickness = ( \frac{1}{Theoretical Consolidated Density} ) \times ( \frac{GSM}{1000} )$$

The loftability factor provides a convenient measure of how many times the consolidated thickness the material can expand. Such information is useful when materials are compared over a range of weights because the void percentage remains constant.

The moldable composite sheet material of the invention includes a thermoplastic core that comprises a thermoplastic resin, discontinuous fibers dispersed within the thermoplastic resin, expandable polymeric beads (which may be contained within the thermoplastic core or the thermoplastic resin, or both), and, optionally, one or more skin layers on the surface of the fiber-containing thermoplastic resin. Generally, the expandable polymeric beads are present within the thermoplastic core, and may also be contained at least partly within the thermoplastic resin.

As described herein, the moldable composite sheet material of the invention exhibits improved sound absorption characteristics relative to the comparative composite material. Sound absorption characteristics may be evaluated by a variety of techniques; e.g., sound absorption generally may be evaluated through measurements of airflow resistance. Increased specific airflow resistance generally equates to increased sound absorption characteristics. For the purposes of the invention, sound absorption characteristics have been evaluated through the measurement of specific airflow resistance according to ASTM test method ASTM C 522-03. Relative to the comparative composite material described herein, applicants have determined that appreciable increases in specific airflow resistance, and thus sound absorption, may be obtained for the inventive composite material. In one embodiment of the invention, the specific airflow resistance of the composite material may be at least about 50% greater than the comparative composite material; more particularly, the specific airflow resistance of the composite material may be at least about 100% greater than the comparative composite material. In another aspect, the composite material has a specific airflow resistance ranging from about 200 to about 9000 Pa·sec/m. The composite material may also have a loftability factor ranging from about 3 to about 11, more particularly from about 4 or 5 to about 11, and still more particularly, from about 6 to about 11.

The composite material of the invention and the comparative composite material may be closely similar in that they differ in only one feature or characteristic, or may differ in more than such feature or characteristic. In one embodiment, the composite material and the comparative composite material differ only in the inclusion of the expandable polymeric beads within the thermoplastic core of the composite material, where the comparative composite material does not contain the expandable polymeric beads of the composite material. In another aspect, the fibers of the composite material comprise glass fibers and the fiber content of the thermoplastic core of the composite material is about the same as or less than the glass fiber content of the thermoplastic core of the comparative composite material. In a further embodiment, the composite material and the comparative composite material are both in sheet form.

Although not specifically required, in one embodiment, the fiber content of the thermoplastic core of the composite material is about the same as or less than the fiber content of the thermoplastic core of the comparative composite material. In addition, the basis weight of the composite material may be about the same as or less than the comparative composite material. The basis weight of the composite material may also be advantageously reduced relative to the comparative composite material, and is particularly at least about 10% less than the comparative composite material.

The thermoplastic resin may generally be any thermoplastic resin having a melt temperature below the resin degradation temperature. Non-limiting examples of such resins include polyolefins such as polyethylene and polypropylene, thermoplastic polyolefin blends, polyesters, polycarbonates, polystyrenes, polyvinyl polymers, butadiene polymers, acrylic polymers, polyamides, polyestercarbonates, acrylonitrylstyrene polymers, acrylonitrile-butylacrylate-styrene polymers, polyether imide, polyphenylene ether, polyphenylene oxide, polyphenylenesulphide, polyethers, polyetherketones, polyacetals, polyurethanes, polybenzimidazole, and copolymers or mixtures thereof. Other suitable thermoplastic resins will be apparent to the skilled artisan.

Fibers suitable for use in the invention include glass fibers, carbon fibers, synthetic organic fibers, particularly high modulus organic fibers such as para- and meta-aramid fibers, natural fibers such as hemp and sisal, mineral fibers such as basalt, mineral wool, wollastonite, alumina silica, or mixtures thereof. Other fibers, such as graphite fibers, inorganic fibers, metal fibers, metalized inorganic fibers, metalized synthetic fibers, ceramic fibers, or a combination of the foregoing may be utilized. Typically, the fiber content is from about 20% to about 80% by weight of the thermoplastic resin. Fibers suitable for use herein are further described in the patent literature (as noted below), and typically have dimensions in the range of about 7 mm to about 50 mm in length with the diameter not less than about 7 microns.

As the thermoplastic resin containing dispersed fibers, the composite material of the invention may, according to one embodiment, include a low density glass mat thermoplastic composite (GMT). One such mat is prepared by AZDEL, Inc. and sold under the trademark SUPERLITE® mat. Preferably, the areal density of such a GMT, and, in general, the composite material of the invention, is from about 400 grams per square meter of the GMT (g/m²) to about 4000 g/m², although the areal density may be less than 400 g/m² or greater than 4000 g/m² depending on the specific application needs. Preferably, the upper density should be less than about 4000 g/m².

The SUPERLITE® mat is prepared using chopped glass fibers, a thermoplastic resin binder and a thermoplastic polymer film or films and or woven or non-woven fabrics made with glass fibers or thermoplastic resin fibers such as polypropylene (PP), polybutylene terephthalate (PBT), polyethylene terephthalate (PET), polycarbonate (PC), a blend of PC/PBT, or a blend of PC/PET. Generally, PP, PBT, PET, and PC/PET and PC/PBT blends are the preferred thermoplastic resins. To produce the low density GMT, the materials and other additives are metered into a dispersing foam contained in an open top mixing tank fitted with an impeller. The foam aides in dispersing the glass fibers and thermoplastic resin binder. The dispersed mixture of glass and thermoplastics binder is pumped to a head-box located above a wire section of a paper machine via a distribution manifold. The foam, not the glass fiber or thermoplastic binder, is then removed as the dispersed mixture passes through a moving wire screen using a vacuum, continuously producing a uniform, fibrous wet web. The wet web is passed through a dryer to reduce moisture content and to melt the thermoplastic resin binder. When the hot web comes out of the dryer, a multi-layer thermoplastic film is typically laminated into the web by passing the web of glass fiber, thermoplastic binder and thermoplastic polymer film or films through the nip of a set of heated rollers. A non-woven and or woven fabric layer may also be attached along with or in place of the multi-layer thermoplastic film to one side or to both sides of the web to facilitate ease of handling the glass fiber-reinforced mat. The SUPERLITE® composite is then passed through tension rolls and continuously cut (guillotined) into the desired size for later forming into an end product article. Further information concerning the preparation of such GMT composites, including suitable materials and fibers used in forming such composites that may also be utilized in the present invention, may be found in a number of U.S. patents, e.g., U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US 2005/0228108, US 2005/0217932, US 2005/0215698, US 2005/0164023, and US 2005/0161865.

The acoustical performance characteristics of such GMT composites have also been investigated and reported (e.g., V. Raghavendran et al., “Development of Low Density GMT Headliners with Improved Acoustical Performance,” ACCE publication, 2001.)

Natural (e.g., hemp, sisal) and/or synthetic fibers such as glass fibers, carbon fibers, organic fibers such as para- and meta-polyaramids, polyesters such as polyethylene terephthate fibers, and mineral fibers such as basalt fibers may also be used for the production (as described above) of such a mat for use in the composite sheet of the invention. Also, various amorphous or crystalline thermoplastic resins may be employed such as polyesters (PET, PBT, PPT), acrylics, HDPE, polyethylene (PET), polypropylene (PP), polycarbonate (PC) or blends of PC/PBT or PC/PET and the like thermoplastic polymers without modification of the web forming process. The ratio of fibers to polymers, as well as the basic weight of the web, can be easily varied in order to meet the particular requirements of cost and material performance of a specific application.

Additional information concerning suitable thermoplastic resins and fibers, as well as details concerning wet-laid manufacturing methods useful in the present invention, may be found in patents assigned to K-Plasheet (e.g., U.S. Pat. Nos. 5,981,046 and 6,756,099).

The present invention includes an “expandable” polymeric bead component that typically expands due to the application of heat. Among such materials, microspheres (e.g., hollow microballoons or microbubbles) find prevalent use in industry, most commonly as additives or fillers. One benefit of microspheres over fillers (e.g., silicates, aluminates, clays, talcs, and the like) is that the hollow feature of the microsphere results in weight reduction. Microspheres also provide a means of introducing controlled, small voids in a closed-cell configuration. This can be difficult to obtain in both viscous and non-viscous fluids, resins, coatings, and cements using conventional foaming agents due to problems associated with the foaming process such as unequal cell growth, time- and temperature-dependent gas diffusion, cell coalescence, and the like. Thus, microspheres provide a means for uniformly and homogeneously increasing product bulk or loft of a composite sheet while simultaneously decreasing the overall density, lowering product cost on a volumetric basis without sacrificing (or while enhancing) performance.

In addition to the benefits of reduced weight and product cost, microspheres offer many other advantages in a wide variety of applications. For example, an overall increased volume load capacity (i.e., higher loading capacities) in turn provides dimensional stability, improved range of application, and further overall weight or density reduction.

The “microspheres” of the invention are particles of thermoplastic resin material. In some aspect the microsphere may have incorporated therein a chemical (e.g., hydrocarbon) or physical blowing agent, and which may be expanded upon heating. The microspheres useful in the invention may generally have any desired diameter; e.g., they may have an average diameter of from about 5 to about 150 μm. Typically, the average diameter is about 10 to about 16 μm in an unexpanded state, and, in an expanded state, a diameter of about 15 to about 90 μm, typically about 40 to about 60 μm. The microspheres may be used in either an expanded or unexpanded state, or blends of both when utilized in the invention. Any suitable thermoplastic resin material may be used to make up the microspheres, including, for example, polystyrene, styrene copolymers, acrylonitrile polymers, polyvinyl chloride, vinyl chloride copolymers, vinylidene chloride copolymers, polyimide polymers, and the like. The thermoplastic synthetic resin material is typically solid at room temperature.

Suitable microspheres may also include those made from inorganic materials such as glass and silica-alumina ceramics or polymeric materials such as epoxy resin, unsaturated polyester resin, silicone resin, phenolics, polyvinyl alcohol, polyvinyl chloride, polypropylene, and polystyrene. In addition, fly ash that is in the form of hollow particles can be used. Examples of commercially available fly ash of this type is sold by Boliden Intertrade, Inc., under the trade names Fillite 100 and Fillite 150. The microspheres advantageously have a burst pressure sufficient to withstand the forces imposed upon them during the formulation, mixing and dispensing processes. Microspheres having an 80% or greater survival rate when exposed to at least 750 psi are preferred, and those having an 80% or greater survival rate when exposed up to 5500 psi are more preferred. In addition, the microspheres typically have a low bulk density of from about 0.1 to about 0.5 g/cc.

The microspheres may include a chemical or physical blowing agent within the sphere that permits them to be expanded upon heating. Any suitable blowing agent may be used provided that it causes the microspheres to expand upon heating. For example, suitable blowing agents may include azodicarbonamide, isobutane, pentane, isopentane, CO₂, and/or freon. If desired, the microspheres may be surface treated with an interfacial adhesion promoter such as a silane compound.

An “expandable polymeric microsphere” is a microsphere that includes a polymer shell and a core material in the form of a gas, liquid, or combination thereof, which expands upon heating. Expansion of the core material, in turn, causes the shell to expand, at least at the heating temperature. An expandable microsphere is one where the shell can be initially expanded or further expanded without breaking. Some microspheres may have polymer shells that only allow the core material to expand at or near the heating temperature. In one aspect, the expandable microsphere does not include a binding agent (e.g., a binder phase) found in most syntactic foam preparations. For example, a binderless expandable microsphere includes microspheres that are capable of increasing in size upon heating due to the formation of one or more gaseous voids or bubbles in the interior of the particle to give a microbubble or microballoon. Such microspheres typically comprise a hollow particle defined by having a polymeric shell wall surrounding one or more internal, gaseous voids. The lack of a binder agent reduces costs, simplifies processing, increases efficiency, and avoids the use of noxious chemical agents. Of particular importance is that binderless expandable microspheres are capable of fusing to one another, to fibrous material in a composite mixture, or a combination of both. The term “fusible” generally means able to fuse together into a connected mass comprising a fibrous material.

Expandable microspheres (which can comprise, for example, volatile physical blowing agents such as hydrocarbons or halocarbons encapsulated in thermoplastic shells) can be used in the methods and compositions of the invention. Expandable microspheres are available from Akzo Nobel AB under the trademark EXPANCEL. The amount and type of expandable microsphere utilized may each be readily varied to obtain the desired degree of expansion (typically, from about 5% to about 150%, more typically from about 35% to about 70%).

Some types of microspheres require binding phases. For example, syntactic foams require a binder phase in order to promote adhesion between microspheres, i.e., to support and reinforce glass microspheres, giving greater strength for a given density. However, excessive rigidity may result in cracking, particularly under thermal shock and cycling. In addition, some binders contribute to increased foam density and are thus less desirable.

Production methods and compositions for microspheres made from various glass, metallic, or polymeric materials have been disclosed, patented, or used in the past, e.g. see U.S. Pat. Nos. 3,615,972, 3,838,998, 3,888,957, 3,933,955, 3,945,956, 4,049,604, 4,075,134, 4,133,854, 4,257,798, 4,303,603, 4,349,456, 4,661,137, 4,767,726, 4,782,097, 4,983,550, 5,069,702, 5,053,436, 5,077,241, and 5,225,123.

Although not strictly limited thereto, the expandable polymeric bead content of the composite sheet is generally from greater than 0 gsm to about 25 gsm.

The thermoplastic core of the composite material may have a porosity between about 0% to about 95%, more particularly between about 30% to about 80%, by volume of the thermoplastic core. As described above, the thermoplastic core may typically have an areal density between about 400 g/m² to about 4000 g/m², although higher or lower densities may be utilized if desired. Although not limited thereto, in one aspect of the invention, the thermoplastic core may be prepared by a method comprising, adding reinforcing fibers, expandable polymeric beads, and a thermoplastic resin to an agitated liquid-containing foam to form a dispersed mixture of thermoplastic resin, reinforcing fibers, and expandable polymeric beads; depositing the dispersed mixture of the thermoplastic resin, fibers and beads onto a forming support element; evacuating the liquid to form a web; heating the web above the softening temperature of the thermoplastic resin; and compressing the web to a predetermined thickness to form the thermoplastic core.

The mat may be desirably formed into an article by a forming technique such as compression molding or thermoforming, using air or gas pressure as an assist, if desired. Such methods are well-known and described in the literature, e.g., see U.S. Pat. Nos. 6,923,494 and 5,601,679. Thermoforming methods and tools are also described in detail in DuBois and Pribble's “Plastics Mold Engineering Handbook”, Fifth Edition, 1995, pages 468 to 498. Although not limited thereto, a low density glass mat thermoplastic (GMT) composite is preferably used.

The optional skin layer of the moldable composite sheet material may generally be a thermoplastic material applied to the surface of the fiber-containing thermoplastic resin. The skin layer may be, without limitation, a film, non-woven scrim, veil, woven fabric or a combination thereof. The skin layer is desirably air permeable and can substantially stretch and spread with the fiber-containing composite sheet during thermoforming and/or molding operations. If desired, the skin layer may also be a film that contains perforations and possesses adhesive characteristics so that it provides good adhesion to a cover sheet material applied to the skin layer. Such perforated adhesive films may provide enhanced acoustical performance by absorbing, attenuating and reducing the amount of sound intensity transmitted across an article prepared from the moldable composite sheet material. While not being limited thereto, the improved sound absorption capabilities desirably exceed an NRC-rating (noise reduction coefficient) of 0.5. In another aspect, one of the skin layers may be a film that contains a higher temperature barrier layer capable of maintaining the air barrier performance to restrict the flow of air through the composite sheet to improve sound transmission loss performance.

The moldable composite sheet material may also be useful in a variety of applications in which stringent performance characteristics must be met. For example, as described in copending Provisional Application Ser. No. 60/795,852, it is desirable that certain durability requirements be achieved for automotive interior parts. Of particular interest is the ability of moldable composite sheet materials to meet the requirement that the adhesion of a surface cover material to the composite sheet of the invention be greater than a minimum peel strength and not exhibit substrate delamination following exposure to specified temperature and humidity requirements (Holden Limited requirement HN 1311 substrate adhesion durability requirement, section 4, clauses 4.3 and 4.8 for type 4 classified parts).

Although not limited thereto, the invention is useful in the manufacture of automotive articles, such as a headliner, door module, instrument panel topper, front and/or rear pillar trim, side wall panels, cargo liners, a sunshade, a parcel shelf, or a package tray, in which the improved thermal adhesive characteristics provide advantages over other materials utilized for such applications.

It is to be understood that while the invention has been described in conjunction with the preferred specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

### EXPERIMENTAL

Porous composite sheets were manufactured using the wet-lay papermaking process (as described and referenced herein) containing finely dispersed filamentized chopped glass fibers having nominal diameters ranging from 13-19 microns and average chopped fiber lengths of 0.5 or 0.75 inch and polypropylene resin uniformly distributed through the thickness of the composite sheets. Samples were prepared containing microspheres with the expandable polymeric bead loading ranging from greater than 0 wt. % to about 25 wt. %. Reference samples without microspheres were also prepared for comparative purposes to illustrate the effect of incorporating microspheres. The weight of the composite sheets ranged from 804 gsm to 1104 gsm (gsm=g/m²).

The composite sheets were laminated using a pair of nip rollers, with a skin layer on both surfaces comprising a polyethylene terephthalate (PET polyester) spunbound non-woven scrim fabric nominally weighing 17 g/m² and an ethylene vinylacetate (EVA) adhesive nominally weighing 10 gsm (27 gsm nominal film weight).

The incorporated microsphere component a thermoplastic outer shell and a liquid hydrocarbon core.

Sample specimens were tested for each microsphere and glass fiber content condition by subjecting them to specific airflow resistance measurement tests according to ASTM C 522-03 (“Standard Test Method for Airflow Resistance of Acoustical Materials”).

### REFERENCE EXAMPLES (WITHOUT MICROSPHERES)

### Specific Airflow Resistance Measurements

Composite sheet samples were prepared without microspheres as described above containing nominal 0.75 inch, 19 micron diameter glass fibers in polypropylene resin at glass fiber loading contents of 50 wt. % and 60 wt. %. The sheet thicknesses for these samples ranged from 2 to 5 mm and the total gsm values ranged from 804 to 1104 gsm. Sample parameters and specific airflow resistance results for these samples are summarized in Tables 1a and 1b.

TABLE 1a
Specific Airflow Resistance for Reference Samples without Microspheres
(60 wt % glass loading, 804 and 904 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-073 | 804 | 19 | 0.75 | 60 | 2 | 0 | 292.63 |
| TECH 2-073 | 804 | 19 | 0.75 | 60 | 2 | 0 | 270.34 |
| TECH 2-073 | 804 | 19 | 0.75 | 60 | 2 | 0 | 323.06 |
| TECH 2-073 | 804 | 19 | 0.75 | 60 | 3 | 0 | 160.13 |
| TECH 2-073 | 804 | 19 | 0.75 | 60 | 3 | 0 | 175.02 |
| TECH 2-073 | 804 | 19 | 0.75 | 60 | 3 | 0 | 153.39 |
| TECH 2-073 | 804 | 19 | 0.75 | 60 | 4 | 0 | 99.02 |
| TECH 2-073 | 804 | 19 | 0.75 | 60 | 4 | 0 | 100.67 |
| TECH 2-073 | 804 | 19 | 0.75 | 60 | 4 | 0 | 118.43 |
| TECH 2-074 | 904 | 19 | 0.75 | 60 | 2 | 0 | 422.5 |
| TECH 2-074 | 904 | 19 | 0.75 | 60 | 2 | 0 | 624.25 |
| TECH 2-074 | 904 | 19 | 0.75 | 60 | 2 | 0 | 493.89 |
| TECH 2-074 | 904 | 19 | 0.75 | 60 | 2.75 | 0 | 235.31 |
| TECH 2-074 | 904 | 19 | 0.75 | 60 | 2.75 | 0 | 201.58 |
| TECH 2-074 | 904 | 19 | 0.75 | 60 | 2.75 | 0 | 213.59 |
| TECH 2-074 | 904 | 19 | 0.75 | 60 | 4 | 0 | 184.81 |
| TECH 2-074 | 904 | 19 | 0.75 | 60 | 4 | 0 | 156.18 |
| TECH 2-074 | 904 | 19 | 0.75 | 60 | 4 | 0 | 128.63 |

TABLE 1b
Specific Airflow Resistance for Reference Samples without Microspheres
(50 wt % glass loading, 804 to 1104 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-080 | 804 | 19 | 0.75 | 50 | 2 | 0 | 288.7 |
| TECH 2-080 | 804 | 19 | 0.75 | 50 | 2 | 0 | 277.7 |
| TECH 2-080 | 804 | 19 | 0.75 | 50 | 2 | 0 | 285.7 |
| TECH 2-080 | 804 | 19 | 0.75 | 50 | 3 | 0 | 167.9 |
| TECH 2-080 | 804 | 19 | 0.75 | 50 | 3 | 0 | 171.1 |
| TECH 2-080 | 804 | 19 | 0.75 | 50 | 3 | 0 | 159.9 |
| TECH 2-080 | 804 | 19 | 0.75 | 50 | 4 | 0 | 118.4 |
| TECH 2-080 | 804 | 19 | 0.75 | 50 | 4 | 0 | 117.6 |
| TECH 2-080 | 804 | 19 | 0.75 | 50 | 4 | 0 | 125.6 |
| TECH 2-081 | 904 | 19 | 0.75 | 50 | 2.75 | 0 | 231.1 |
| TECH 2-081 | 904 | 19 | 0.75 | 50 | 2.75 | 0 | 211.9 |
| TECH 2-081 | 904 | 19 | 0.75 | 50 | 2.75 | 0 | 216.5 |
| TECH 2-081 | 904 | 19 | 0.75 | 50 | 3 | 0 | 219.1 |
| TECH 2-081 | 904 | 19 | 0.75 | 50 | 3 | 0 | 202 |
| TECH 2-081 | 904 | 19 | 0.75 | 50 | 3 | 0 | 193.4 |
| TECH 2-081 | 904 | 19 | 0.75 | 50 | 3.25 | 0 | 176.8 |
| TECH 2-081 | 904 | 19 | 0.75 | 50 | 3.25 | 0 | 161.7 |
| TECH 2-081 | 904 | 19 | 0.75 | 50 | 3.25 | 0 | 177.65 |
| TECH 2-081 | 904 | 19 | 0.75 | 50 | 3.5 | 0 | 146.2 |
| TECH 2-081 | 904 | 19 | 0.75 | 50 | 3.5 | 0 | 184.8 |
| TECH 2-081 | 904 | 19 | 0.75 | 50 | 3.5 | 0 | 156 |
| TECH 2-081 | 904 | 19 | 0.75 | 50 | 4 | 0 | 151.9 |
| TECH 2-081 | 904 | 19 | 0.75 | 50 | 4 | 0 | 147 |
| TECH 2-081 | 904 | 19 | 0.75 | 50 | 4 | 0 | 162.9 |
| TECH 2-081 | 904 | 19 | 0.75 | 50 | 5 | 0 | 102.5 |
| TECH 2-081 | 904 | 19 | 0.75 | 50 | 5 | 0 | 120.6 |
| TECH 2-081 | 904 | 19 | 0.75 | 50 | 5 | 0 | 114.1 |
| TECH 2-078 | 1004 | 19 | 0.75 | 50 | 2.75 | 0 | 263.8 |
| TECH 2-078 | 1004 | 19 | 0.75 | 50 | 2.75 | 0 | 299.9 |
| TECH 2-078 | 1004 | 19 | 0.75 | 50 | 2.75 | 0 | 226.5 |
| TECH 2-078 | 1004 | 19 | 0.75 | 50 | 4 | 0 | 247.1 |
| TECH 2-078 | 1004 | 19 | 0.75 | 50 | 4 | 0 | 218.5 |
| TECH 2-078 | 1004 | 19 | 0.75 | 50 | 4 | 0 | 233 |
| TECH 2-078 | 1004 | 19 | 0.75 | 50 | 5 | 0 | 128.7 |
| TECH 2-078 | 1004 | 19 | 0.75 | 50 | 5 | 0 | 137.7 |
| TECH 2-078 | 1004 | 19 | 0.75 | 50 | 5 | 0 | 135.2 |
| TECH 2-082 | 1004 | 19 | 0.75 | 50 | 2.75 | 0 | 290 |
| TECH 2-082 | 1004 | 19 | 0.75 | 50 | 2.75 | 0 | 306.7 |
| TECH 2-082 | 1004 | 19 | 0.75 | 50 | 2.75 | 0 | 311 |
| TECH 2-082 | 1004 | 19 | 0.75 | 50 | 4 | 0 | 174 |
| TECH 2-082 | 1004 | 19 | 0.75 | 50 | 4 | 0 | 160 |
| TECH 2-082 | 1004 | 19 | 0.75 | 50 | 4 | 0 | 170 |
| TECH 2-082 | 1004 | 19 | 0.75 | 50 | 5 | 0 | 140.7 |
| TECH 2-082 | 1004 | 19 | 0.75 | 50 | 5 | 0 | 156.3 |
| TECH 2-082 | 1004 | 19 | 0.75 | 50 | 5 | 0 | 154.6 |
| TECH 2-079 | 1104 | 19 | 0.75 | 50 | 2.75 | 0 | 353.3 |
| TECH 2-079 | 1104 | 19 | 0.75 | 50 | 2.75 | 0 | 358.6 |
| TECH 2-079 | 1104 | 19 | 0.75 | 50 | 4 | 0 | 191 |
| TECH 2-079 | 1104 | 19 | 0.75 | 50 | 4 | 0 | 182.2 |
| TECH 2-079 | 1104 | 19 | 0.75 | 50 | 4 | 0 | 172 |
| TECH 2-079 | 1104 | 19 | 0.75 | 50 | 5 | 0 | 147 |
| TECH 2-079 | 1104 | 19 | 0.75 | 50 | 5 | 0 | 152 |
| TECH 2-079 | 1104 | 19 | 0.75 | 50 | 5 | 0 | 165.6 |
| TECH 2-083 | 1104 | 19 | 0.75 | 50 | 2.75 | 0 | 462 |
| TECH 2-083 | 1104 | 19 | 0.75 | 50 | 2.75 | 0 | 576 |
| TECH 2-083 | 1104 | 19 | 0.75 | 50 | 2.75 | 0 | 717 |
| TECH 2-083 | 1104 | 19 | 0.75 | 50 | 4 | 0 | 456 |
| TECH 2-083 | 1104 | 19 | 0.75 | 50 | 4 | 0 | 238.6 |
| TECH 2-083 | 1104 | 19 | 0.75 | 50 | 4 | 0 | 283.3 |
| TECH 2-083 | 1104 | 19 | 0.75 | 50 | 5 | 0 | 187.9 |
| TECH 2-083 | 1104 | 19 | 0.75 | 50 | 5 | 0 | 180.6 |
| TECH 2-083 | 1104 | 19 | 0.75 | 50 | 5 | 0 | 211 |

### EXAMPLES (WITH MICROSPHERES)

### Specific Airflow Resistance Measurements

Composite sheet samples were prepared containing microspheres as described above containing nominal 0.5 or 0.75 inch glass fibers having diameters of 13, 16, or 19 microns in polypropylene resin at glass fiber loading contents of 50 wt. %, 55 wt. %, or 60 wt. %. The sheet thicknesses for these samples ranged from 1 to 6 mm and the total gsm values ranged from 584 to 1104 gsm. Sample parameters and specific airflow resistance results for these samples are summarized in Tables 2a to 2e.

TABLE 2a
Specific Airflow Resistance for Samples with Microspheres (584 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-101 | 584 | 19 | 0.75 | 60 | 1 | 6.8 | 2041.8 |
| TECH 2-101 | 584 | 19 | 0.75 | 60 | 1 | 6.8 | 1791.2 |
| TECH 2-101 | 584 | 19 | 0.75 | 60 | 1 | 6.8 | 2339.1 |
| TECH 2-101 | 584 | 19 | 0.75 | 60 | 2 | 6.8 | 296.1 |
| TECH 2-101 | 584 | 19 | 0.75 | 60 | 2 | 6.8 | 284 |
| TECH 2-101 | 584 | 19 | 0.75 | 60 | 2 | 6.8 | 283.2 |
| TECH 2-101 | 584 | 19 | 0.75 | 60 | 3 | 6.8 | 173 |
| TECH 2-101 | 584 | 19 | 0.75 | 60 | 3 | 6.8 | 177.7 |
| TECH 2-101 | 584 | 19 | 0.75 | 60 | 3 | 6.8 | 207.3 |
| TECH 2-101 | 584 | 19 | 0.75 | 60 | 4 | 6.8 | 139.1 |
| TECH 2-101 | 584 | 19 | 0.75 | 60 | 4 | 6.8 | 116.6 |
| TECH 2-101 | 584 | 19 | 0.75 | 60 | 4 | 6.8 | 121.5 |
| TECH 2-096 | 584 | 16 | 0.5 | 55 | 2 | 11.7 | 1163.8 |
| TECH 2-096 | 584 | 16 | 0.5 | 55 | 2 | 11.7 | 1463.4 |
| TECH 2-096 | 584 | 16 | 0.5 | 55 | 2 | 11.7 | 1174.1 |
| TECH 2-096 | 584 | 16 | 0.5 | 55 | 3 | 11.7 | 462.6 |
| TECH 2-096 | 584 | 16 | 0.5 | 55 | 3 | 11.7 | 392.9 |
| TECH 2-096 | 584 | 16 | 0.5 | 55 | 3 | 11.7 | 382.7 |
| TECH 2-096 | 584 | 16 | 0.5 | 55 | 4 | 11.7 | 173.8 |
| TECH 2-096 | 584 | 16 | 0.5 | 55 | 4 | 11.7 | 155.2 |
| TECH 2-096 | 584 | 16 | 0.5 | 55 | 4 | 11.7 | 125.6 |

TABLE 2b
Specific Airflow Resistance for Samples with Microspheres (804 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-100 | 804 | 19 | 0.75 | 60 | 2 | 9.4 | 3358.8 |
| TECH 2-100 | 804 | 19 | 0.75 | 60 | 2 | 9.4 | 2612.6 |
| TECH 2-100 | 804 | 19 | 0.75 | 60 | 2 | 9.4 | 1991.6 |
| TECH 2-100 | 804 | 19 | 0.75 | 60 | 3 | 9.4 | 476.5 |
| TECH 2-100 | 804 | 19 | 0.75 | 60 | 3 | 9.4 | 472.8 |
| TECH 2-100 | 804 | 19 | 0.75 | 60 | 3 | 9.4 | 435.9 |
| TECH 2-100 | 804 | 19 | 0.75 | 60 | 4 | 9.4 | 303.8 |
| TECH 2-100 | 804 | 19 | 0.75 | 60 | 4 | 9.4 | 343.2 |
| TECH 2-100 | 804 | 19 | 0.75 | 60 | 4 | 9.4 | 330.3 |
| TECH 2-100 | 804 | 19 | 0.75 | 60 | 5 | 9.4 | 259.7 |
| TECH 2-100 | 804 | 19 | 0.75 | 60 | 5 | 9.4 | 221.7 |
| TECH 2-100 | 804 | 19 | 0.75 | 60 | 5 | 9.4 | 236.9 |
| TECH 2-095 | 804 | 16 | 0.5 | 55 | 2 | 12.2 | 954.1 |
| TECH 2-095 | 804 | 16 | 0.5 | 55 | 2 | 12.2 | 1467.5 |
| TECH 2-095 | 804 | 16 | 0.5 | 55 | 2 | 12.2 | 1183.7 |
| TECH 2-095 | 804 | 16 | 0.5 | 55 | 3 | 12.2 | 247.9 |
| TECH 2-095 | 804 | 16 | 0.5 | 55 | 3 | 12.2 | 327.2 |
| TECH 2-095 | 804 | 16 | 0.5 | 55 | 3 | 12.2 | 383.1 |
| TECH 2-095 | 804 | 16 | 0.5 | 55 | 4 | 12.2 | 203.4 |
| TECH 2-095 | 804 | 16 | 0.5 | 55 | 4 | 12.2 | 182.2 |
| TECH 2-095 | 804 | 16 | 0.5 | 55 | 4 | 12.2 | 169.3 |
| TECH 2-095 | 804 | 16 | 0.5 | 55 | 5 | 12.2 | 106.9 |
| TECH 2-095 | 804 | 16 | 0.5 | 55 | 5 | 12.2 | 142.5 |
| TECH 2-095 | 804 | 16 | 0.5 | 55 | 5 | 12.2 | 151.7 |
| TECH 2-091 | 804 | 16 | 0.5 | 55 | 3 | 15 | 1701.7 |
| TECH 2-091 | 804 | 16 | 0.5 | 55 | 3 | 15 | 1698.9 |
| TECH 2-091 | 804 | 16 | 0.5 | 55 | 3 | 15 | 1579.2 |
| TECH 2-091 | 804 | 16 | 0.5 | 55 | 4 | 15 | 480.7 |
| TECH 2-091 | 804 | 16 | 0.5 | 55 | 4 | 15 | 413.5 |
| TECH 2-091 | 804 | 16 | 0.5 | 55 | 4 | 15 | 433.5 |
| TECH 2-091 | 804 | 16 | 0.5 | 55 | 5 | 15 | 271 |
| TECH 2-091 | 804 | 16 | 0.5 | 55 | 5 | 15 | 271.8 |
| TECH 2-091 | 804 | 16 | 0.5 | 55 | 5 | 15 | 268 |
| TECH 2-084 | 804 | 13 | 0.5 | 50 | 2 | 15.1 | 5940 |
| TECH 2-084 | 804 | 13 | 0.5 | 50 | 2 | 15.1 | 8183 |
| TECH 2-084 | 804 | 13 | 0.5 | 50 | 2 | 15.1 | 5723 |
| TECH 2-084 | 804 | 13 | 0.5 | 50 | 3 | 15.1 | 966 |
| TECH 2-084 | 804 | 13 | 0.5 | 50 | 3 | 15.1 | 942.9 |
| TECH 2-084 | 804 | 13 | 0.5 | 50 | 3 | 15.1 | 903.8 |
| TECH 2-084 | 804 | 13 | 0.5 | 50 | 4 | 15.1 | 505.4 |
| TECH 2-084 | 804 | 13 | 0.5 | 50 | 4 | 15.1 | 451 |
| TECH 2-084 | 804 | 13 | 0.5 | 50 | 4 | 15.1 | 454.9 |
| TECH 2-084 | 804 | 13 | 0.5 | 50 | 5 | 15.1 | 405 |
| TECH 2-084 | 804 | 13 | 0.5 | 50 | 5 | 15.1 | 391 |
| TECH 2-084 | 804 | 13 | 0.5 | 50 | 5 | 15.1 | 419.9 |

TABLE 2c
Specific Airflow Resistance for Samples with Microspheres (904 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-102 | 904 | 19 | 0.75 | 60 | 2 | 9.7 | 5633.8 |
| TECH 2-102 | 904 | 19 | 0.75 | 60 | 2 | 9.7 | 4257.5 |
| TECH 2-102 | 904 | 19 | 0.75 | 60 | 2 | 9.7 | 7405.7 |
| TECH 2-102 | 904 | 19 | 0.75 | 60 | 2.75 | 9.7 | 1187.3 |
| TECH 2-102 | 904 | 19 | 0.75 | 60 | 2.75 | 9.7 | 1538 |
| TECH 2-102 | 904 | 19 | 0.75 | 60 | 2.75 | 9.7 | 1259.9 |
| TECH 2-102 | 904 | 19 | 0.75 | 60 | 4 | 9.7 | 368.1 |
| TECH 2-102 | 904 | 19 | 0.75 | 60 | 4 | 9.7 | 410.7 |
| TECH 2-102 | 904 | 19 | 0.75 | 60 | 4 | 9.7 | 343 |
| TECH 2-102 | 904 | 19 | 0.75 | 60 | 5 | 9.7 | 230.4 |
| TECH 2-102 | 904 | 19 | 0.75 | 60 | 5 | 9.7 | 219.9 |
| TECH 2-102 | 904 | 19 | 0.75 | 60 | 5 | 9.7 | 280.8 |
| TECH 2-092 | 904 | 16 | 0.5 | 55 | 2.75 | 10.6 | 1955.1 |
| TECH 2-092 | 904 | 16 | 0.5 | 55 | 2.75 | 10.6 | 2171.7 |
| TECH 2-092 | 904 | 16 | 0.5 | 55 | 2.75 | 10.6 | 1925.5 |
| TECH 2-092 | 904 | 16 | 0.5 | 55 | 4 | 10.6 | 562.4 |
| TECH 2-092 | 904 | 16 | 0.5 | 55 | 4 | 10.6 | 557.5 |
| TECH 2-092 | 904 | 16 | 0.5 | 55 | 4 | 10.6 | 610.8 |
| TECH 2-092 | 904 | 16 | 0.5 | 55 | 5 | 10.6 | 359.8 |
| TECH 2-092 | 904 | 16 | 0.5 | 55 | 5 | 10.6 | 368.8 |
| TECH 2-092 | 904 | 16 | 0.5 | 55 | 5 | 10.6 | 369.6 |
| TECH 2-086 | 904 | 13 | 0.5 | 50 | 2.75 | 13.2 | 2606 |
| TECH 2-086 | 904 | 13 | 0.5 | 50 | 2.75 | 13.2 | 2798 |
| TECH 2-086 | 904 | 13 | 0.5 | 50 | 2.75 | 13.2 | 2293 |
| TECH 2-086 | 904 | 13 | 0.5 | 50 | 3 | 13.2 | 2850 |
| TECH 2-086 | 904 | 13 | 0.5 | 50 | 3 | 13.2 | 2414 |
| TECH 2-086 | 904 | 13 | 0.5 | 50 | 3 | 13.2 | 2839 |
| TECH 2-086 | 904 | 13 | 0.5 | 50 | 3.25 | 13.2 | 1614.9 |
| TECH 2-086 | 904 | 13 | 0.5 | 50 | 3.25 | 13.2 | 1426 |
| TECH 2-086 | 904 | 13 | 0.5 | 50 | 3.25 | 13.2 | 1448 |
| TECH 2-086 | 904 | 13 | 0.5 | 50 | 3.5 | 13.2 | 1284 |
| TECH 2-086 | 904 | 13 | 0.5 | 50 | 3.5 | 13.2 | 1311 |
| TECH 2-086 | 904 | 13 | 0.5 | 50 | 3.5 | 13.2 | 1049 |
| TECH 2-086 | 904 | 13 | 0.5 | 50 | 4 | 13.2 | 604.5 |
| TECH 2-086 | 904 | 13 | 0.5 | 50 | 4 | 13.2 | 673 |
| TECH 2-086 | 904 | 13 | 0.5 | 50 | 4 | 13.2 | 524 |
| TECH 2-086 | 904 | 13 | 0.5 | 50 | 5 | 13.2 | 329 |
| TECH 2-086 | 904 | 13 | 0.5 | 50 | 5 | 13.2 | 329 |
| TECH 2-086 | 904 | 13 | 0.5 | 50 | 5 | 13.2 | 392 |
| TECH 2-097 | 904 | 16 | 0.5 | 55 | 4 | 19.4 | 1352.1 |
| TECH 2-097 | 904 | 16 | 0.5 | 55 | 4 | 19.4 | 1324.3 |
| TECH 2-097 | 904 | 16 | 0.5 | 55 | 4 | 19.4 | 1388.5 |
| TECH 2-097 | 904 | 16 | 0.5 | 55 | 5 | 19.4 | 515 |
| TECH 2-097 | 904 | 16 | 0.5 | 55 | 5 | 19.4 | 560.8 |
| TECH 2-097 | 904 | 16 | 0.5 | 55 | 5 | 19.4 | 823.1 |

TABLE 2d
Specific Airflow Resistance for Samples with Microspheres (1004 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-103 | 1004 | 19 | 0.75 | 60 | 2.75 | 9.3 | 4188.6 |
| TECH 2-103 | 1004 | 19 | 0.75 | 60 | 2.75 | 9.3 | 3953 |
| TECH 2-103 | 1004 | 19 | 0.75 | 60 | 2.75 | 9.3 | 4169.3 |
| TECH 2-103 | 1004 | 19 | 0.75 | 60 | 4 | 9.3 | 742.3 |
| TECH 2-103 | 1004 | 19 | 0.75 | 60 | 4 | 9.3 | 603.4 |
| TECH 2-103 | 1004 | 19 | 0.75 | 60 | 4 | 9.3 | 505.3 |
| TECH 2-103 | 1004 | 19 | 0.75 | 60 | 5 | 9.3 | 390.3 |
| TECH 2-103 | 1004 | 19 | 0.75 | 60 | 5 | 9.3 | 366.2 |
| TECH 2-103 | 1004 | 19 | 0.75 | 60 | 5 | 9.3 | 365.7 |
| TECH 2-103 | 1004 | 19 | 0.75 | 60 | 6 | 9.3 | 272.2 |
| TECH 2-103 | 1004 | 19 | 0.75 | 60 | 6 | 9.3 | 289.6 |
| TECH 2-103 | 1004 | 19 | 0.75 | 60 | 6 | 9.3 | 250.5 |
| TECH 2-087 | 1004 | 13 | 0.5 | 50 | 4 | 15.3 | 755 |
| TECH 2-087 | 1004 | 13 | 0.5 | 50 | 4 | 15.3 | 767 |
| TECH 2-087 | 1004 | 13 | 0.5 | 50 | 4 | 15.3 | 795 |
| TECH 2-087 | 1004 | 13 | 0.5 | 50 | 5 | 15.3 | 364.5 |
| TECH 2-087 | 1004 | 13 | 0.5 | 50 | 5 | 15.3 | 403.5 |
| TECH 2-087 | 1004 | 13 | 0.5 | 50 | 5 | 15.3 | 378.6 |
| TECH 2-087 | 1004 | 13 | 0.5 | 50 | 6 | 15.3 | 346.7 |
| TECH 2-087 | 1004 | 13 | 0.5 | 50 | 6 | 15.3 | 348 |
| TECH 2-087 | 1004 | 13 | 0.5 | 50 | 6 | 15.3 | 335 |
| TECH 2-093 | 1004 | 16 | 0.5 | 55 | 2.75 | 15.6 | 5325.9 |
| TECH 2-093 | 1004 | 16 | 0.5 | 55 | 2.75 | 15.6 | 5168.5 |
| TECH 2-093 | 1004 | 16 | 0.5 | 55 | 2.75 | 15.6 | 4307.1 |
| TECH 2-093 | 1004 | 16 | 0.5 | 55 | 4 | 15.6 | 917.7 |
| TECH 2-093 | 1004 | 16 | 0.5 | 55 | 4 | 15.6 | 886.5 |
| TECH 2-093 | 1004 | 16 | 0.5 | 55 | 4 | 15.6 | 787 |
| TECH 2-093 | 1004 | 16 | 0.5 | 55 | 5 | 15.6 | 396.7 |
| TECH 2-093 | 1004 | 16 | 0.5 | 55 | 5 | 15.6 | 366.9 |
| TECH 2-093 | 1004 | 16 | 0.5 | 55 | 5 | 15.6 | 378.6 |
| TECH 2-093 | 1004 | 16 | 0.5 | 55 | 6 | 15.6 | 348.6 |
| TECH 2-093 | 1004 | 16 | 0.5 | 55 | 6 | 15.6 | 335.9 |
| TECH 2-093 | 1004 | 16 | 0.5 | 55 | 6 | 15.6 | 373.1 |
| TECH 2-098 | 1004 | 16 | 0.5 | 55 | 4 | 19.7 | 5214.3 |
| TECH 2-098 | 1004 | 16 | 0.5 | 55 | 4 | 19.7 | 4470 |
| TECH 2-098 | 1004 | 16 | 0.5 | 55 | 4 | 19.7 | 3773.2 |
| TECH 2-098 | 1004 | 16 | 0.5 | 55 | 5 | 19.7 | 1372.1 |
| TECH 2-098 | 1004 | 16 | 0.5 | 55 | 5 | 19.7 | 908.6 |
| TECH 2-098 | 1004 | 16 | 0.5 | 55 | 5 | 19.7 | 630.1 |
| TECH 2-098 | 1004 | 16 | 0.5 | 55 | 6 | 19.7 | 708.1 |
| TECH 2-098 | 1004 | 16 | 0.5 | 55 | 6 | 19.7 | 518.9 |
| TECH 2-098 | 1004 | 16 | 0.5 | 55 | 6 | 19.7 | 403 |

TABLE 2e
Specific Airflow Resistance for Samples with Microspheres (1104 gsm)

| | | | Glass | | | | Specific Airflow |
|---|---|---|---|---|---|---|---|
| | | Glass Fiber | Fiber | Glass | | Microsphere | Resistance |
| Sample | Total | diameter | length | Loading | Thickness | Loading | (mks rayls) or |
| Number | GSM | (microns) | (inch) | (wt %) | (mm) | (GSM) | [Pa · s/m] |
| TECH 2-104 | 1104 | 19 | 0.75 | 60 | 2.75 | 12.3 | 3417.6 |
| TECH 2-104 | 1104 | 19 | 0.75 | 60 | 2.75 | 12.3 | 5013.5 |
| TECH 2-104 | 1104 | 19 | 0.75 | 60 | 2.75 | 12.3 | 3426.4 |
| TECH 2-104 | 1104 | 19 | 0.75 | 60 | 4 | 12.3 | 1003.6 |
| TECH 2-104 | 1104 | 19 | 0.75 | 60 | 4 | 12.3 | 1188 |
| TECH 2-104 | 1104 | 19 | 0.75 | 60 | 4 | 12.3 | 969.6 |
| TECH 2-104 | 1104 | 19 | 0.75 | 60 | 5 | 12.3 | 477.4 |
| TECH 2-104 | 1104 | 19 | 0.75 | 60 | 5 | 12.3 | 473.6 |
| TECH 2-104 | 1104 | 19 | 0.75 | 60 | 5 | 12.3 | 406.4 |
| TECH 2-104 | 1104 | 19 | 0.75 | 60 | 6 | 12.3 | 385.6 |
| TECH 2-104 | 1104 | 19 | 0.75 | 60 | 6 | 12.3 | 445.8 |
| TECH 2-104 | 1104 | 19 | 0.75 | 60 | 6 | 12.3 | 398.8 |
| TECH 2-099 | 1104 | 16 | 0.5 | 55 | 4 | 12.9 | 3929.9 |
| TECH 2-099 | 1104 | 16 | 0.5 | 55 | 4 | 12.9 | 1181.8 |
| TECH 2-099 | 1104 | 16 | 0.5 | 55 | 4 | 12.9 | 1959.7 |
| TECH 2-099 | 1104 | 16 | 0.5 | 55 | 5 | 12.9 | 1725.9 |
| TECH 2-099 | 1104 | 16 | 0.5 | 55 | 5 | 12.9 | 1384 |
| TECH 2-099 | 1104 | 16 | 0.5 | 55 | 5 | 12.9 | 1103 |
| TECH 2-099 | 1104 | 16 | 0.5 | 55 | 6 | 12.9 | 1186.9 |
| TECH 2-099 | 1104 | 16 | 0.5 | 55 | 6 | 12.9 | 1090.9 |
| TECH 2-099 | 1104 | 16 | 0.5 | 55 | 6 | 12.9 | 2796.5 |
| TECH 2-088 | 1104 | 13 | 0.5 | 50 | 2.75 | 13.9 | 8086 |
| TECH 2-088 | 1104 | 13 | 0.5 | 50 | 2.75 | 13.9 | 9449 |
| TECH 2-088 | 1104 | 13 | 0.5 | 50 | 2.75 | 13.9 | 5996 |
| TECH 2-088 | 1104 | 13 | 0.5 | 50 | 4 | 13.9 | 923 |
| TECH 2-088 | 1104 | 13 | 0.5 | 50 | 4 | 13.9 | 1038 |
| TECH 2-088 | 1104 | 13 | 0.5 | 50 | 4 | 13.9 | 931 |
| TECH 2-088 | 1104 | 13 | 0.5 | 50 | 5 | 13.9 | 613 |
| TECH 2-088 | 1104 | 13 | 0.5 | 50 | 5 | 13.9 | 590 |
| TECH 2-088 | 1104 | 13 | 0.5 | 50 | 5 | 13.9 | 535 |
| TECH 2-088 | 1104 | 13 | 0.5 | 50 | 6 | 13.9 | 404 |
| TECH 2-088 | 1104 | 13 | 0.5 | 50 | 6 | 13.9 | 377 |
| TECH 2-088 | 1104 | 13 | 0.5 | 50 | 6 | 13.9 | 396.6 |
| TECH 2-094 | 1104 | 16 | 0.5 | 55 | 4 | 24.8 | 828.5 |
| TECH 2-094 | 1104 | 16 | 0.5 | 55 | 4 | 24.8 | 830.7 |
| TECH 2-094 | 1104 | 16 | 0.5 | 55 | 4 | 24.8 | 1037.7 |
| TECH 2-094 | 1104 | 16 | 0.5 | 55 | 5 | 24.8 | 451.1 |
| TECH 2-094 | 1104 | 16 | 0.5 | 55 | 5 | 24.8 | 439.2 |
| TECH 2-094 | 1104 | 16 | 0.5 | 55 | 5 | 24.8 | 504.8 |
| TECH 2-094 | 1104 | 16 | 0.5 | 55 | 6 | 24.8 | 349.6 |
| TECH 2-094 | 1104 | 16 | 0.5 | 55 | 6 | 24.8 | 318.4 |
| TECH 2-094 | 1104 | 16 | 0.5 | 55 | 6 | 24.8 | 351.4 |

Comparison of the foregoing airflow resistance measurements generally shows that the addition of microspheres greatly increases the airflow resistance compared with samples that do not contain microspheres.

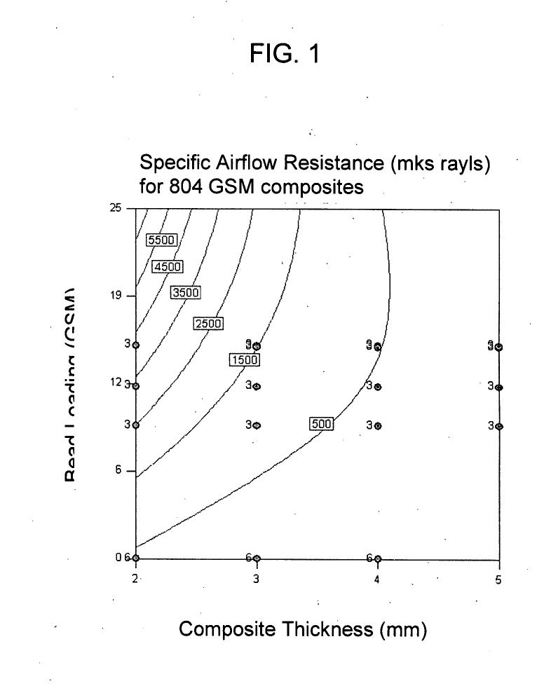

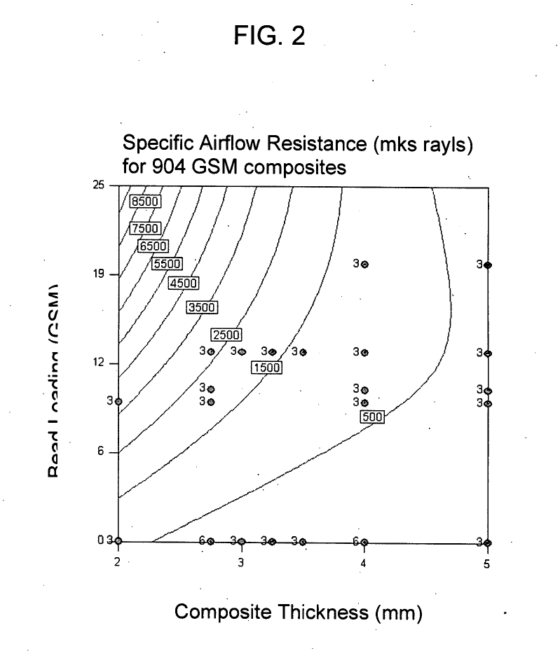

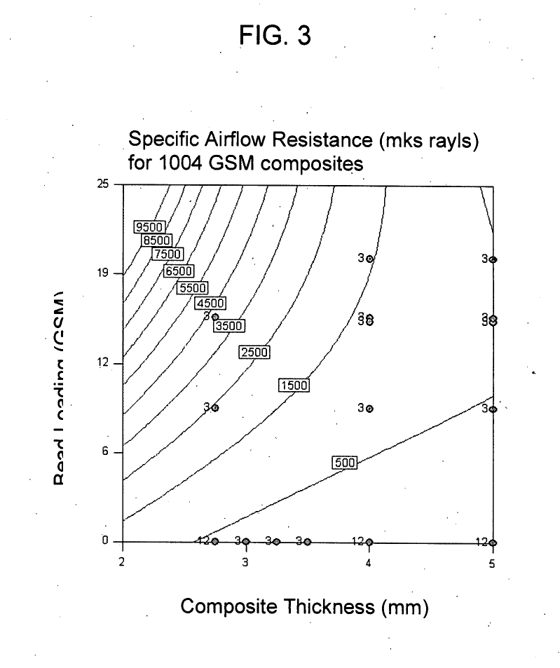

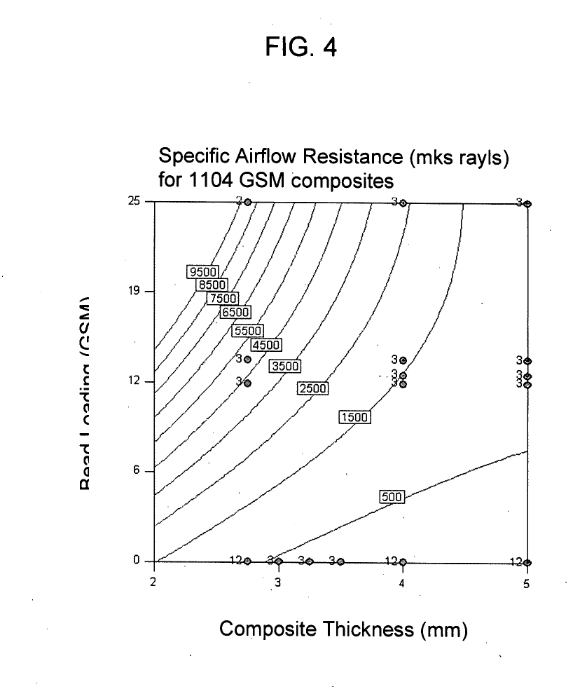

The results were further analyzed using an analysis of variance, resulting in the development of a model and contour plots over the entire parameter space. The main factors for the specific airflow resistance of the composite materials are composite gsm, composite thickness, and microsphere loading. The contour plots are illustrated in FIGS. 1-4 as model predictions based on analyzing specific airflow resistance data investigating the impact bead loading, with the data points indicating experiment locations of data collection and the number of data points collected. The contour lines are airflow resistance values based on model predictions.

The ANOVA results are summarized below with the model equation coefficients. The ANOVA model is significant with a significant lack of fit. Three main factors are significant: thickness, Total GSM, and bead loading, along with five secondary interactions. With an R² value of 0.81, the model fit is good compared to the actual experimental data.

TABLE 3
ANOVA for Response Surface Reduced Quadratic Model
Analysis of variance table [Partial sum of squares]

| Source | Sum of Squares | Prob > F | |
|---|---|---|---|
| Model | 76615 | <0.0001 | significant |
| A: Thickness | 4753 | <0.0001 | |
| B: Total GSM | 15882 | <0.0001 | |
| C: Bead loading | 2827 | <0.0001 | |
| A² | 7213 | <0.0001 | |
| C² | 891 | <0.0001 | |
| AB | 3857 | <0.0001 | |
| AC | 13713 | <0.0001 | |
| BC | 2288 | <0.0001 | |
| Lack of Fit | 15345 | <0.0001 | significant |

The 95% confidence intervals for each coefficient, along with the final equation in terms of the coded factors, are shown below:

Final equation in terms of coded factors:

| | 95% CI | 95% CI |
|---|---|---|
| Sqrt(airflow) = | Low | High |
| 378.5 | 338.7 | 418.3 |
| −369.6 * A | −447.0 | −292.1 |
| 405.8 * B | 359.3 | 452.3 |
| 223.3 * C | 162.7 | 284.0 |
| 29.9 * A² | 24.8 | 35.0 |
| −6.1 * C² | −9.0 | −3.1 |
| −387.4 * A * B | −477.5 | −297.3 |
| −31.2 * A * C | −35.1 | −27.4 |
| 241.7 * B * C | 168.7 | 314.7 |

### Loftability Factor Determination

Results for the composite sheet samples prepared containing microspheres as described above were further evaluated to determine the loftability factor relative to the microsphere loading. Sample identification and parameters from the foregoing tables are partially reproduced in Table 4 along with the loftability factor and microsphere loading percentage. As may be generally noted, the specific airflow resistance in significantly higher at lower loftability factor values.

TABLE 4
Loftability Factors for Samples with Microspheres

| | | | | | | | | | Specific |
|---|---|---|---|---|---|---|---|---|---|
| | | | | Glass | Glass | | | | Airflow |
| | | | | Fiber | Fiber | Glass | | Microsphere | Resistance |
| Sample | Loftability | % of | Total | diameter | length | Loading | Thickness | Loading | (mks rayls) or |
| Number | Factor | Microsphere | GSM | (μm) | (inch) | (wt %) | (mm) | (GSM) | [Pa · s/m] |
| TECH 2-084 | 3.4 | 1.9 | 804 | 13 | 0.5 | 50 | 2 | 15.1 | 5940 |
| TECH 2-084 | 3.4 | 1.9 | 804 | 13 | 0.5 | 50 | 2 | 15.1 | 8183 |
| TECH 2-084 | 3.4 | 1.9 | 804 | 13 | 0.5 | 50 | 2 | 15.1 | 5723 |
| TECH 2-088 | 3.4 | 1.3 | 1104 | 13 | 0.5 | 50 | 2.75 | 13.9 | 8086 |
| TECH 2-088 | 3.4 | 1.3 | 1104 | 13 | 0.5 | 50 | 2.75 | 13.9 | 9449 |
| TECH 2-088 | 3.4 | 1.3 | 1104 | 13 | 0.5 | 50 | 2.75 | 13.9 | 5996 |
| TECH 2-086 | 4.1 | 1.5 | 904 | 13 | 0.5 | 50 | 2.75 | 13.2 | 2606 |
| TECH 2-086 | 4.1 | 1.5 | 904 | 13 | 0.5 | 50 | 2.75 | 13.2 | 2798 |
| TECH 2-086 | 4.1 | 1.5 | 904 | 13 | 0.5 | 50 | 2.75 | 13.2 | 2293 |
| TECH 2-086 | 4.5 | 1.5 | 904 | 13 | 0.5 | 50 | 3 | 13.2 | 2850 |
| TECH 2-086 | 4.5 | 1.5 | 904 | 13 | 0.5 | 50 | 3 | 13.2 | 2414 |
| TECH 2-086 | 4.5 | 1.5 | 904 | 13 | 0.5 | 50 | 3 | 13.2 | 2839 |
| TECH 2-085 | 4.6 | 1.9 | 584 | 13 | 0.5 | 50 | 2 | 11 | 934.8 |
| TECH 2-085 | 4.6 | 1.9 | 584 | 13 | 0.5 | 50 | 2 | 11 | 1130 |
| TECH 2-085 | 4.6 | 1.9 | 584 | 13 | 0.5 | 50 | 2 | 11 | 750 |
| TECH 2-086 | 4.9 | 1.5 | 904 | 13 | 0.5 | 50 | 3.25 | 13.2 | 1614.9 |
| TECH 2-086 | 4.9 | 1.5 | 904 | 13 | 0.5 | 50 | 3.25 | 13.2 | 1426 |
| TECH 2-086 | 4.9 | 1.5 | 904 | 13 | 0.5 | 50 | 3.25 | 13.2 | 1448 |
| TECH 2-088 | 4.9 | 1.3 | 1104 | 13 | 0.5 | 50 | 4 | 13.9 | 923 |
| TECH 2-088 | 4.9 | 1.3 | 1104 | 13 | 0.5 | 50 | 4 | 13.9 | 1038 |
| TECH 2-088 | 4.9 | 1.3 | 1104 | 13 | 0.5 | 50 | 4 | 13.9 | 931 |
| TECH 2-084 | 5.0 | 1.9 | 804 | 13 | 0.5 | 50 | 3 | 15.1 | 966 |
| TECH 2-084 | 5.0 | 1.9 | 804 | 13 | 0.5 | 50 | 3 | 15.1 | 942.9 |
| TECH 2-084 | 5.0 | 1.9 | 804 | 13 | 0.5 | 50 | 3 | 15.1 | 903.8 |
| TECH 2-086 | 5.2 | 1.5 | 904 | 13 | 0.5 | 50 | 3.5 | 13.2 | 1284 |
| TECH 2-086 | 5.2 | 1.5 | 904 | 13 | 0.5 | 50 | 3.5 | 13.2 | 1311 |
| TECH 2-086 | 5.2 | 1.5 | 904 | 13 | 0.5 | 50 | 3.5 | 13.2 | 1049 |
| TECH 2-087 | 5.4 | 1.5 | 1004 | 13 | 0.5 | 50 | 4 | 15.3 | 755 |
| TECH 2-087 | 5.4 | 1.5 | 1004 | 13 | 0.5 | 50 | 4 | 15.3 | 767 |
| TECH 2-087 | 5.4 | 1.5 | 1004 | 13 | 0.5 | 50 | 4 | 15.3 | 795 |
| TECH 2-086 | 6.0 | 1.5 | 904 | 13 | 0.5 | 50 | 4 | 13.2 | 604.5 |
| TECH 2-086 | 6.0 | 1.5 | 904 | 13 | 0.5 | 50 | 4 | 13.2 | 673 |
| TECH 2-086 | 6.0 | 1.5 | 904 | 13 | 0.5 | 50 | 4 | 13.2 | 524 |
| TECH 2-088 | 6.1 | 1.3 | 1104 | 13 | 0.5 | 50 | 5 | 13.9 | 613 |
| TECH 2-088 | 6.1 | 1.3 | 1104 | 13 | 0.5 | 50 | 5 | 13.9 | 590 |
| TECH 2-088 | 6.1 | 1.3 | 1104 | 13 | 0.5 | 50 | 5 | 13.9 | 535 |
| TECH 2-084 | 6.7 | 1.9 | 804 | 13 | 0.5 | 50 | 4 | 15.1 | 505.4 |
| TECH 2-084 | 6.7 | 1.9 | 804 | 13 | 0.5 | 50 | 4 | 15.1 | 451 |
| TECH 2-084 | 6.7 | 1.9 | 804 | 13 | 0.5 | 50 | 4 | 15.1 | 454.9 |
| TECH 2-087 | 6.7 | 1.5 | 1004 | 13 | 0.5 | 50 | 5 | 15.3 | 364.5 |
| TECH 2-087 | 6.7 | 1.5 | 1004 | 13 | 0.5 | 50 | 5 | 15.3 | 403.5 |
| TECH 2-087 | 6.7 | 1.5 | 1004 | 13 | 0.5 | 50 | 5 | 15.3 | 378.6 |
| TECH 2-085 | 6.9 | 1.9 | 584 | 13 | 0.5 | 50 | 3 | 11 | 243 |
| TECH 2-085 | 6.9 | 1.9 | 584 | 13 | 0.5 | 50 | 3 | 11 | 252.8 |
| TECH 2-085 | 6.9 | 1.9 | 584 | 13 | 0.5 | 50 | 3 | 11 | 270 |
| TECH 2-088 | 7.3 | 1.3 | 1104 | 13 | 0.5 | 50 | 6 | 13.9 | 404 |
| TECH 2-088 | 7.3 | 1.3 | 1104 | 13 | 0.5 | 50 | 6 | 13.9 | 377 |
| TECH 2-088 | 7.3 | 1.3 | 1104 | 13 | 0.5 | 50 | 6 | 13.9 | 396.6 |
| TECH 2-086 | 7.5 | 1.5 | 904 | 13 | 0.5 | 50 | 5 | 13.2 | 329 |
| TECH 2-086 | 7.5 | 1.5 | 904 | 13 | 0.5 | 50 | 5 | 13.2 | 329 |
| TECH 2-086 | 7.5 | 1.5 | 904 | 13 | 0.5 | 50 | 5 | 13.2 | 392 |
| TECH 2-087 | 8.1 | 1.5 | 1004 | 13 | 0.5 | 50 | 6 | 15.3 | 346.7 |
| TECH 2-087 | 8.1 | 1.5 | 1004 | 13 | 0.5 | 50 | 6 | 15.3 | 348 |
| TECH 2-087 | 8.1 | 1.5 | 1004 | 13 | 0.5 | 50 | 6 | 15.3 | 335 |
| TECH 2-084 | 8.4 | 1.9 | 804 | 13 | 0.5 | 50 | 5 | 15.1 | 405 |
| TECH 2-084 | 8.4 | 1.9 | 804 | 13 | 0.5 | 50 | 5 | 15.1 | 391 |
| TECH 2-084 | 8.4 | 1.9 | 804 | 13 | 0.5 | 50 | 5 | 15.1 | 419.9 |
| TECH 2-085 | 9.2 | 1.9 | 584 | 13 | 0.5 | 50 | 4 | 11 | 159.9 |
| TECH 2-085 | 9.2 | 1.9 | 584 | 13 | 0.5 | 50 | 4 | 11 | 160.9 |
| TECH 2-085 | 9.2 | 1.9 | 584 | 13 | 0.5 | 50 | 4 | 11 | 176.8 |

What is claimed is:

1. A fiber reinforced thermoplastic composite material comprising a fiber reinforced thermoplastic core comprising
a thermoplastic resin;
discontinuous fibers dispersed within the thermoplastic resin, and
expandable polymeric beads,
wherein, the composite material exhibits improved sound absorption as measured by specific airflow resistance test method ASTM C 522-03 at about the same basis weight or at a reduced basis weight compared to a comparative composite material comprising a glass fiber reinforced thermoplastic core having discontinuous glass fibers dispersed within the thermoplastic core of the comparative composite material.

2. The composite material of claim 1, wherein the fiber content of the thermoplastic core of the composite material is about the same as or less than the fiber content of the thermoplastic core of the comparative composite material.

3. The composite material of claim 1, wherein the specific airflow resistance of the composite material is at least about 50% greater than the comparative composite material.

4. The composite material of claim 1, wherein the specific airflow resistance of the composite material is at least about 100% greater than the comparative composite material.

5. The composite material of claim 1, wherein the basis weight of the composite material is about the same as the comparative composite material.

6. The composite material of claim 1, wherein the basis weight of the composite material is at least about 10% less than the comparative composite material.

7. The composite material of claim 1, wherein the composite material and the comparative composite material are both in sheet form.

8. The composite material of claim 1, wherein the composite material and the comparative composite material differ only in the inclusion of the expandable polymeric beads within the thermoplastic core of the composite material.

9. The composite material of claim 1, wherein the fibers of the composite material comprise glass fibers and the fiber content of the thermoplastic core of the composite material is about the same as or less than the glass fiber content of the thermoplastic core of the comparative composite material.

10. The composite material of claim 1, wherein the composite material has a specific airflow resistance ranging from about 200 to about 9000 Pa·sec/m, a loftability factor ranging from about 3 to about 11, or a combination thereof.

11. The composite material of claim 1, wherein the thermoplastic core has a porosity greater than about 0% to about 95% by volume of the thermoplastic core and an areal density of from about 400 g/m² to about 4000 g/m².

12. The composite material of claim 11, wherein the thermoplastic core has a porosity between about 30% to about 80% by volume of the thermoplastic core.

13. The composite material of claim 1, wherein the fiber content is from about 20 wt. % to about 80 wt. % of the thermoplastic core.

14. The composite material of claim 1, wherein the fiber diameter is greater than about 7 μm.

15. The composite material of claim 1, wherein the fiber length is from about 7 mm to about 50 mm.

16. The composite material of claim 1, wherein the expandable polymeric bead content is from greater than 0 gsm to about 25 gsm.

17. The composite material of claim 1, wherein the thermoplastic resin is selected from polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyether imide, polyphenylene ether, polyphenylene oxide, polyphenylenesulphide, polyethers, polyetherketones, polyacetals, polyurethanes, polybenzimidazole, and copolymers or a mixture thereof.

18. The composite material of claim 1, wherein the fibers comprise fibers selected from glass fibers, carbon fibers, graphite fibers, synthetic organic fibers, inorganic fibers, natural fibers, mineral fibers, metal fibers, metalized inorganic fibers, metalized synthetic fibers, ceramic fibers, or a combination thereof.

19. The composite material of claim 18, wherein the fibers comprise glass fibers, carbon fibers, or mineral fibers selected from basalt, mineral wool, wollastonite, alumina silica, or a combination thereof.

20. The composite material of claim 1, further comprising a skin layer selected from films, non-woven scrims, veils, woven fabrics, or a combination thereof.

21. An article formed from the composite material of claim 1.

22. The article of claim 21, in the form of a construction article, or an automobile article selected from a parcel shelf, package tray, headliner, door module, instrument panel topper, side wall panels, cargo liners, front and/or rear pillar trim, or a sunshade.

23. The composite material of claim 1, wherein the thermoplastic core is prepared by a method comprising,
adding reinforcing fibers, expandable polymeric beads, and a thermoplastic resin to an agitated liquid-containing foam to form a dispersed mixture of thermoplastic resin, reinforcing fibers, and expandable polymeric beads;
depositing the dispersed mixture of the thermoplastic resin, fibers and beads onto a forming support element;
evacuating the liquid to form a web;
heating the web above the softening temperature of the thermoplastic resin; and
compressing the web to a predetermined thickness to form the thermoplastic core.
